(19) United States
(12) Patent Application Publication
(10) Pub. No.: US 2004/0237755 A1
(43) Pub. Date: Dec. 2, 2004

(54) Guitar stand

(76) Inventor: Yuan-Chi Laio, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/445,965

(22) Filed: May 28, 2003

(51) Int. Cl. G10D 3/00; G10G 5/00

(52) U.S. Cl. 84/327

(57) ABSTRACT

A guitar stand includes a standing device having a main tube upwardly extending therefrom. A telescope tube is partially and reciprocally movably and received in the main tube, the telescope tube having a first end movably received in the main tube and a second end having a connector pivotally connected to the telescope. A U-shaped fork longitudinally is secured on a free end of the connector and holds a neck of the guitar in place. A supporting device is pivotally mounted to the main tube supports a body of the guitar. The supporting device includes a shaft and a seat securely mounted to of the shaft. Two supporting rods are respectively pivotally connected to the opposite ends of the seat. Each supporting rod includes a flat section pivotally received in the seat and an expanding section forward extending from each of the supporting rod.

### BACKGROUND OF THE INVENTION

1. Field of the Invention

The present invention relates to stand, and more particularly to a guitar stand that has a small packaged volume.

2. Description of Related Art Block Anxiously

A conventional guitar stand in accordance with the prior art shown in FIG. 8 comprises a foldable base member (7) abutting a supporting surface and a main tube (71) upwardly extending from the base member (7). A telescope tube (72) partially and reciprocally movably received in the main tube (71). The telescope tube (72) has a first end movably received in the main tube (71) and a second end opposite to the first end of the telescope tube (72). A connector (74) includes a first end pivotally connected to the second end of the telescope tube (72) and a second end having a first fork (75) longitudinally secured on the connector (74).

A support (8) is pivotally and detachably mounted to the main tube (71) near the base member (7). The support (8) includes a shaft (81) pivotally inserted into the main tube (71) and a second fork (82) longitudinally securely connected to one end of the shaft (81). The second fork (82) has an extending direction the same as the first fork (75). The second fork (82) has an arc section (83) secured on the shaft (81) to form a U-shaped figure of the second fork (82).

In use, the body of the guitar is mounted on the second fork (82) and the neck of the guitar is located within the first fork (75) such that the guitar stands on the guitar stand.

However, the body of the guitar is wide such that a certain width and length is necessary to the second fork (82) for stably support the guitar. With reference to FIG. 9, the enlarged second fork (82) will increase the packaged volume of the guitar stand and freighting cost.

For reducing the packaged volume of the guitar stand, a foldable second fork (82) is considered. With reference to FIGS. 10 and 11, a hypothetical pivotal axle (84) is situated in the arc section (83) of the second fork (82). The hypothetical axle has an axis directing to a center of the arc section (83) such that the axis is oblique relative to an elongated line of a corresponding one of the supporting section (not numbered) and forms an angle (θ) with the elongated line.

Consequently, the two supporting section of the second fork (82) toward each other after being upwardly folded and the effect of reducing volume of the guitar stand is limited.

The present invention has arisen to mitigate and/or obviate the disadvantages of the conventional guitar stand.

### SUMMARY OF THE INVENTION

The main objective of the present invention is to provide an improved guitar stand that has a small packaged volume.

To achieve the objective, the guitar stand in accordance with the present invention comprises a standing device having a main tube upwardly extending therefrom. A telescope tube is partially and reciprocally movably and received in the main tube, the telescope tube having a first end movably received in the main tube and a second end having a connector pivotally connected to the telescope. A U-shaped fork longitudinally is secured on a free end of the connector and holds a neck of the guitar in place. A supporting device is pivotally mounted to the main tube supports a body of the guitar. The supporting device includes a shaft and a seat securely mounted to of the shaft. Two supporting rods are respectively pivotally connected to the opposite ends of the seat. Each supporting rod includes a flat section pivotally received in the seat and an expanding section forward extending from each of the supporting rod.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a guitar stand in accordance with the present invention;

FIG. 2 is a partially cress-sectional view of the guitar stand in FIG. 1;

FIG. 3 is a top plan view of a supporting device of the guitar stand in FIG. 1;

FIG. 4 is a perspective of the supporting device on the present invention in FIG. 3 when the two expand sections of the supporting device folded to abut each other;

FIG. 5 is top plan view of the supporting device in FIG. 4;

FIG. 6 is a side plan view of the supporting device in FIG. 4;

FIG. 7 is top plan view of the guitar stand of the present invention when the guitar stand is packaged in a box;

FIG. 8 is a perspective view of a conventional guitar stand in accordance with the prior art;

FIG. 9 is a top plan view of the conventional guitar stand when the conventional guitar stand is package in a box;

FIG. 10 is a top plan view of a second fork of the conventional guitar stand in FIG. 8; and

FIG. 11 is a front plan view of the second fork in FIG. 10.

### DETAILED DESCRIPTION OF THE INVENTION

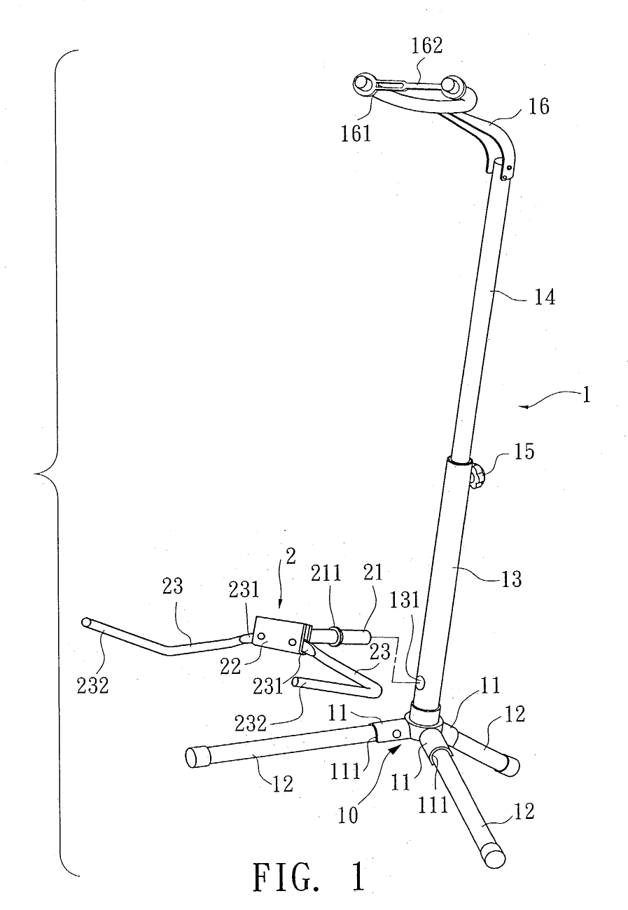

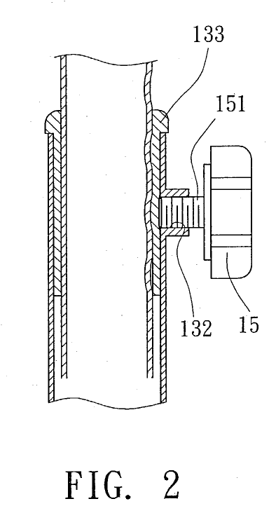

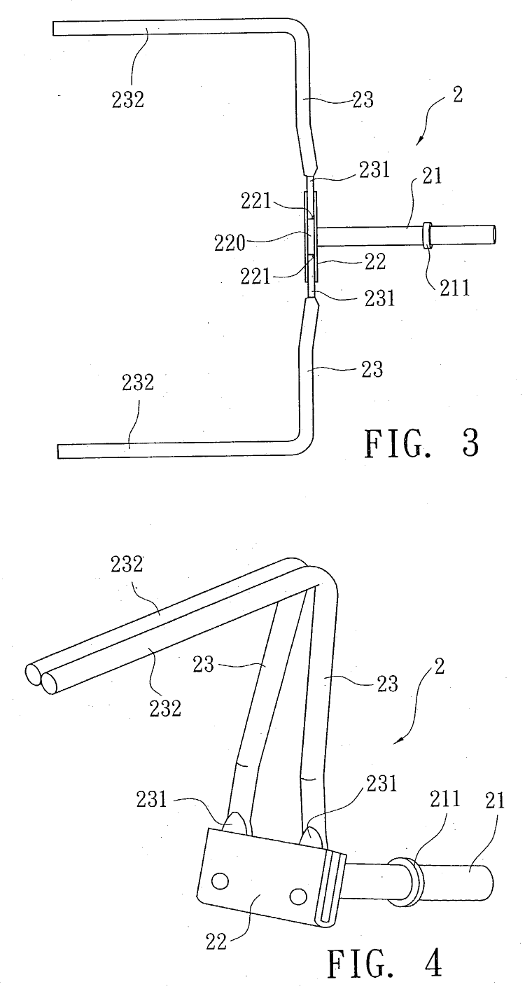

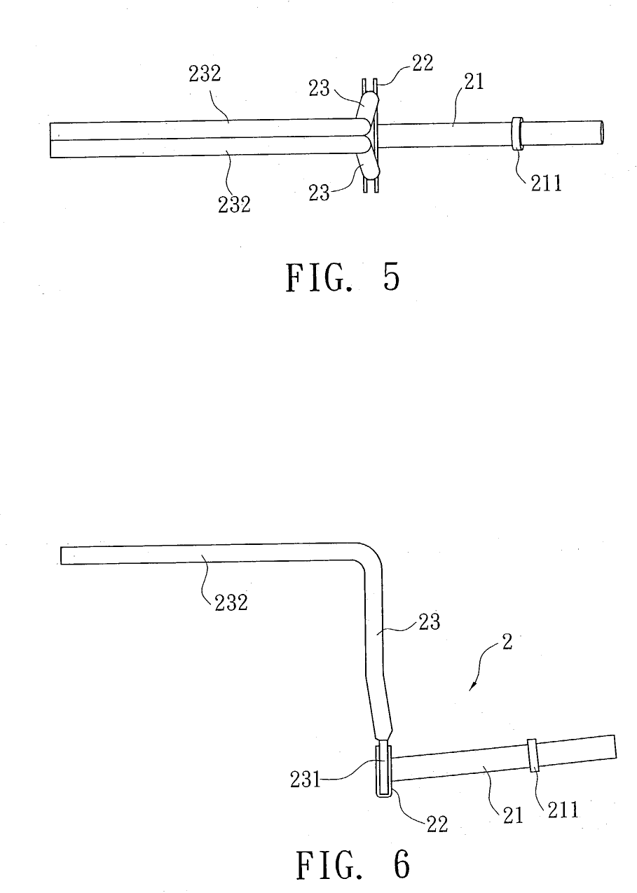

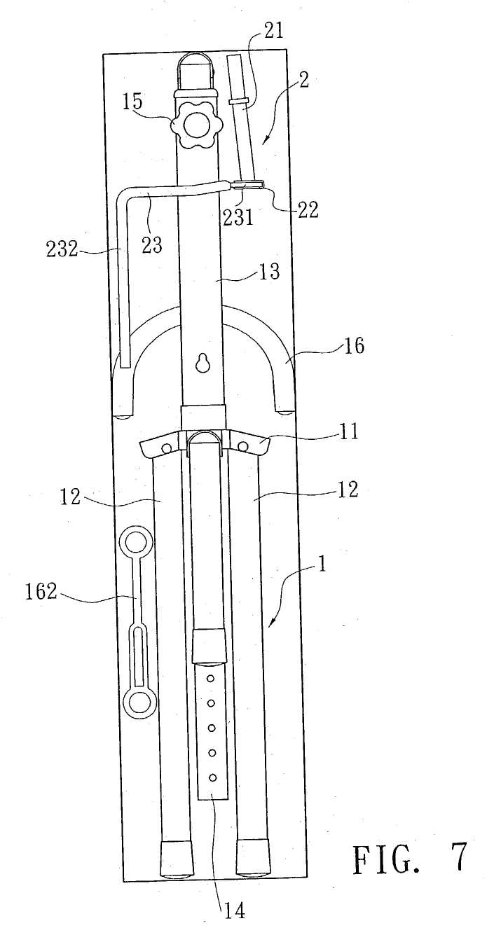

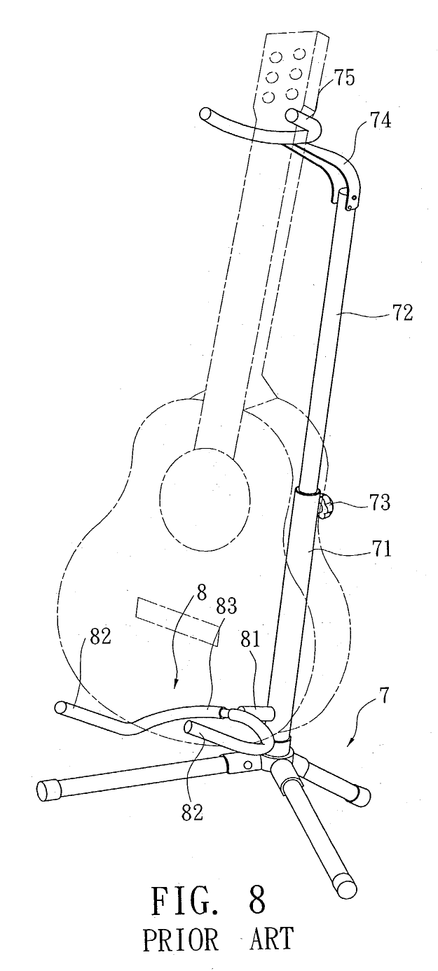

Referring to the drawings and initially to FIGS. 1-6, a guitar stand in accordance with the present invention comprises a standing device (1) adapted to stand on a supporting surface and a supporting device (2) pivotally mounted to the standing device (1).

The standing device (1) comprises a pivot seat (10) including three hollow protrusions (11) radially extending from the pivot seat (10). The three hollow protrusions (11) equally divide a periphery of the pivot seat (10) into three portions. The standing device (1) includes three rods (12) each having a first end received in and pivotally mounted in a corresponding one of the three hollow protrusions (11), and a second end abutting the supporting surface for sustaining the standing device (1). Each hollow protrusion has an opening (111) defined therein and extending toward the supporting surface such that each rod (12) can be downward folded to parallel one another. A main tube (13) upwardly extends from the pivot seat (10). The main tube (13) includes a through hole (131) diametrically defined in a lower end of the main tube (13), and a threaded hole (132) defined in an upper end of the main tube (13) and extending into an inner periphery of the main tube (13). A collar (133) is mounted in the upper end of the main tube (13) and downward extending over the threaded hole (132).

A telescope tube (14) is partially and reciprocally movably and received in the main tube (13), and extending through the collar (133). The telescope tube (14) has a first end movably received in the main tube (13) and a second end opposite to the first end of the telescope tube (14). A knob (15) is mounted to the main tube (13) to hold the telescope tube (14) in place. The knob (15) includes a threaded rod (151) centrally extending from the knob (15). The threaded rod (151) is screwed into the threaded hole (132) and extends to push the collar (133) for securely abutting an outer periphery of the telescope tube (14) when the telescope tube (14) extending to a suitable length relative to the main tube (13). The collar (133) can prevent the outer periphery of the telescope tube (14) from being scraped by a free end of the threaded rod (151).

A connector (16) includes a first end pivotally connected to the second end of the telescope tube (14) and a second end having a U-shaped fork (161) longitudinally secured on the connector (16). A bind (162) is mounted to the fork (161). The bind (162) has two opposite ends each sleeved a corresponding one of the two distal ends to close an open side of the fork (161) to prevent the neck of the guitar from suddenly detaching from the fork (161).

The supporting device (2) includes a shaft (21) having a first end detachably inserted into and pivotally received in the through hole (131) in the main tube (13), and a second end opposite to the first end of the shaft (21). The shaft (21) has an annular stopper (211) laterally extending from the shaft (21) to position the shaft (21) in place when the first end of the shaft (21) is inserted into the through hole (131) in the main tube (13). A seat (22) is securely mounted to the second end of the shaft (21) and has a groove (220) defined in the seat (22). The groove (220) transversely extends through the seat (22). The supporting device (2) includes two supporting rods (23) respectively pivotally connected to the opposite ends of the seat (22). Each supporting rod (23) includes a first end formed a flat section (231) pivotally received in the groove (220) in the seat (22) and a second end having a expanding section (232) forward extending from each of the supporting rod (23). The expanding section (232) of each of the two supporting rods (23) is parallel to the pivot axis of the supporting rod (23) and adapted to support the body of the guitar. The seat (22) includes two bosses (221) laterally extending from a sidewall of the groove (220) in the seat (22) to prevent the two supporting rods (23) from being moved over an axis of the shaft (21).

For folding the guitar stand of the present invention, with reference to FIG. 7, the knob (15) is loosened, the telescope tube is drawn back into the main tube (13), the connector (16) with the fork 161) is wrenched to abut the main tube (13) and the rods (12) are downward wrenched to parallel to one another to reduce the packaged volume of the standing device (1). The supporting device (2) is detached from the main tube (13). The two supporting rods (23) are upwardly wrenched toward each other and the flat section (231) of each of the two supporting rods (23) is pivotally moved within the groove (220) in the seat (22). The two expanding section (232) abut each other after the supporting rods (23) being upwardly wrenched because the pivotal axis of the supporting rod (23) is parallel to the elongate line of the expanding section (232) such that the packaged volume of the supporting device (2) is narrowed to the minimum.

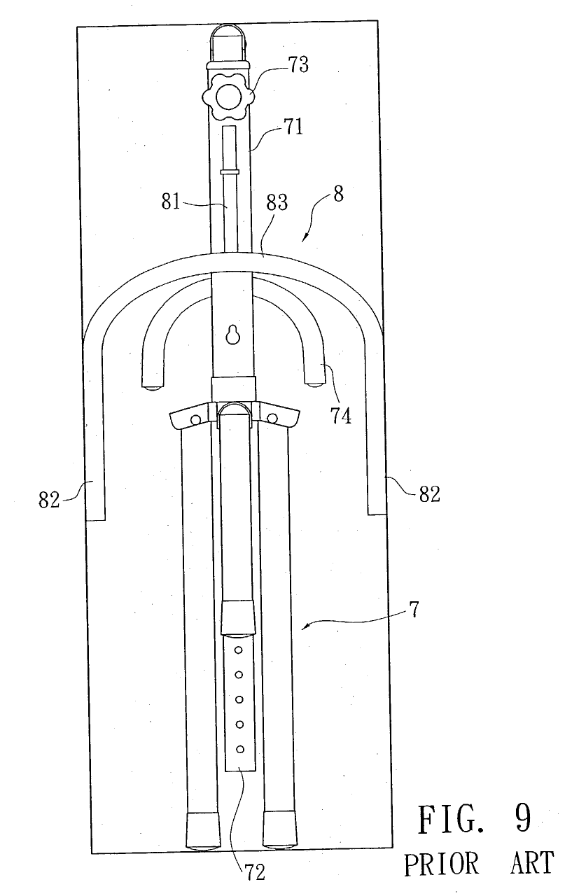

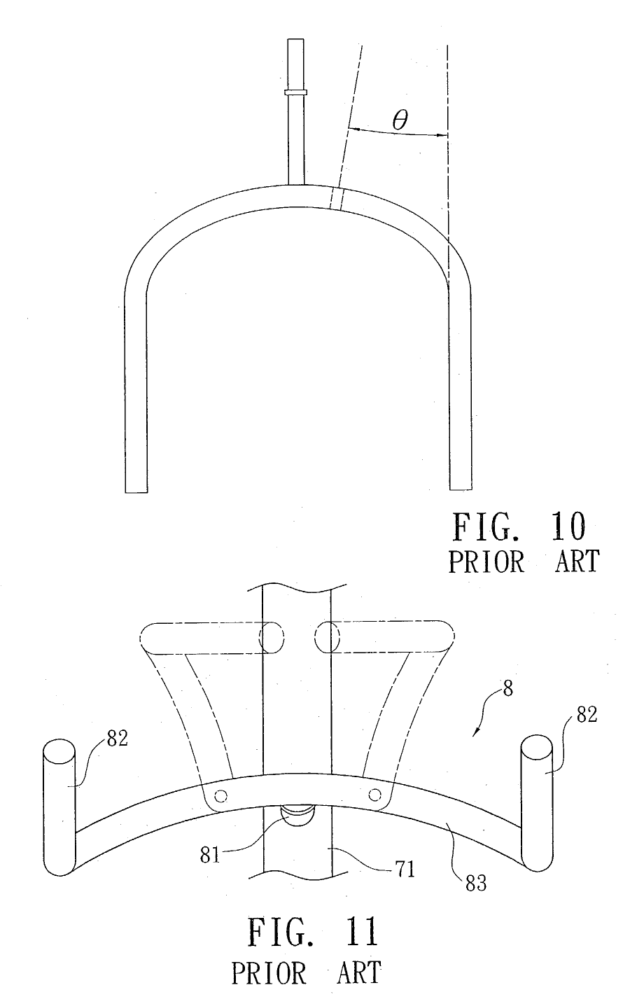

To compare with FIGS. 7 and 9, the width of the box for containing the present invention is equal to that of the fork (16) and the box for containing the conventional guitar stand is equal to that of the second fork. Consequently, we clearly realize that the packaged volume of the present invention is greater smaller than that of the conventional guitar stand. A 40 feet container, for example, only contains about five thousand and four hundred pieces of the packaged conventional guitar stand, but contains about ten thousand and five hundred pieces of the packaged guitar stand in accordance with the present invention. Accordingly, the freighting cost is greatly reduced due to the improved guitar stand in accordance with the present invention.

Although the invention has been explained in relation to its preferred embodiment, it is to be understood that many other possible modifications and variations can be made without departing from the spirit and scope of the invention as hereinafter claimed.

What is claimed is:

1. A guitar stand comprising:
a standing device adapted to stand on a supporting surface, the standing device including a main tube upwardly extending from the standing device, a telescope tube partially and reciprocally movably and received in the main tube, the telescope tube having a first end movably received in the main tube and a second end opposite to the first end of the telescope tube, a connector having a first end pivotally connected to the second end of the telescope and a second end having a U-shaped fork longitudinally secured on the connector, the U-shaped fork adapted to hold a neck of the guitar in place; and
a supporting device pivotally mounted to the main tube of the standing device and adapted to support a body of the guitar, the supporting device including a shaft having a first end pivotally received in the main tube and a second end opposite to the first end of the shaft, a seat securely mounted to the second end of the shaft, the supporting device including two supporting rods respectively pivotally connected to the opposite ends of the seat, each supporting rod including a first end formed a flat section pivotally received in the seat and a second having an expanding section forward extending from each of the supporting rod, the expanding section of each of the two supporting rods adapted to support the body of the guitar and parallel to a pivot axis of the supporting rod.

2. The guitar stand as claimed in claim 1, wherein the seat comprises a groove transversely defined therein for pivotally receiving the flat section of each of the two supporting rods and two bosses laterally extending from a sidewall of the groove in the seat to prevent the two supporting rods from being moved over an axis of the shaft.

3. The guitar stand as claimed in claim 1, wherein standing device comprises a pivot seat and the main tube extending from the pivot seat, the pivot seat including three hollow protrusions radially extending from the pivot seat and equally dividing a periphery of the pivot seat into three portions, the standing device including three rods each having a first end received in and pivotally mounted in a corresponding one of the three hollow protrusions, and a second end adapted to abut the supporting surface for sustaining the standing device, each hollow protrusion having an opening defined therein and extending toward the supporting surface such that each rod can be downward folded to parallel one another.

4. The guitar stand as claimed in claim 1, wherein the main tube comprises a through hole diametrically defined in a lower end of the main tube for pivotally receiving the first end of the shaft and a threaded hole defined in an upper end of the main tube, the threaded hole extending into an inner periphery of the main tube, a knob with a threaded rod that is screwed into the threaded hole in the main tube and extends to push the telescope tube to hold the telescope tube in place.

5. The guitar stand as claimed in claim 4 further comprises a collar mounted in the upper end of the main tube and downward over the threaded hole and the telescope tube extending through the collar, whereby the collar can prevent an outer periphery of the telescope tube from being scraped by a free end of the threaded rod of the knob.
